(19) United States
(12) Patent Application Publication
(10) Pub. No.: US 2025/0171357 A1
(43) Pub. Date: May 29, 2025

(54) RUBBER-PLASTIC-GLASS PAVING BLOCK

(71) Applicant: Allied Success Technology Development Limited, Hong Kong (HK)

(72) Inventors: Chung Kong CHAU, Hong Kong (HK); Chi Fai CHENG, Hong Kong (HK); Nok Hang Enoch WONG, Hong Kong (HK); Allan Sau Kit CHAN, Hong Kong (HK); Ian Pui Hong CHAN, Hong Kong (HK); Man Lung SHAM, Hong Kong (HK); Lai Ming Gordon LEUNG, Hong Kong (HK)

(21) Appl. No.: 18/961,519

(22) Filed: Nov. 27, 2024

Related U.S. Application Data
(60) Provisional application No. 63/602,682, filed on Nov. 27, 2023.

(51) Int. Cl. C04B 24/00; C04B 7/12; C04B 14/06; C04B 14/22; C04B 111/60

(52) U.S. Cl. CPC C04B 24/001; C04B 7/12; C04B 14/06; C04B 14/22; C04B 2111/60

(57) ABSTRACT

An eco-friendly and sustainable paving blocks with considerable recycled waste contents is provided herewith. By various physical and/or chemical treatments, recycled materials are incorporated into the paving blocks which show remarkable mechanical strengths and durability ensuring pedestrians' safety in use and capability in prolonged use, indicating the immense potential for the eco-friendly and sustainable paving blocks to be mass-produced and applied. By incorporating recycled waste tyre rubber, plastic and glass into the formulations, the paving blocks in the present invention are capable of achieving compressive strength levels qualified for pedestrian use, thereby providing an innovative solution to address both the increasing demands of waste recycling and paving blocks usage with large-scale applicability.

### CROSS-REFERENCE TO RELEVANT APPLICATION

The present application claims priority from a U.S. provisional patent application Ser. No. 63/602,682 filed Nov. 27, 2023, and the disclosure of which are incorporated by reference in their entirety.

### FIELD OF THE INVENTION

The present invention relates to eco-friendly paving blocks; more specifically, eco-friendly paving blocks with considerable recycled waste contents are provided herewith, demonstrating high strength, low abrasion resistance and low water absorption, suitable for large-scale production and application.

### BACKGROUND OF THE INVENTION

Modern society produces large amounts of waste materials that are difficult or impossible to recycle and are costly to dispose of. As a metropolitan city, Hong Kong produces a large amount of waste on a daily basis, which in turn poses an immense load to the capacity of the landfills. Statistics from the Hong Kong government shows that, despite a year-on-year increase of more than 20% in the quantity of recovered municipal solid waste for local recycling, the average daily quantity of solid waste to landfill still increased by 5.4% from 2020 to 2021, amounting to 15,533 tonnes of average daily solid waste to landfill in 2021. In particularly, the daily plastic waste to landfill is approximately 2,300 tonnes and the daily rubber waste to landfill is slightly lower than 60 tonnes.

During the COVID pandemic in years 2020 to 2023, the quantity of waste underwent exponential growth due to the increased use of takeout meal boxes, plastic utensils and non-recyclable masks.

As such, with Hong Kong having already filled and closed down 13 landfills; the remaining 3 landfills are expected to be filled up in the 2030s.

Globally, municipal solid waste generation in 2023 is estimated at an approximate 2.1 billion tonnes, and is projected to increase to 3.8 billion tonnes by 2050. Meanwhile, as of 2021, only 9% of the 400 million tonnes of global plastic waste generated was successfully recycled. The unrecycled are either landfilled, incinerated or leaked into the environment. The demand for waste recycling remains extremely high.

In Hong Kong, as well as other urban centers, there are large areas of paved areas, including walkways, driveways, and alleys. For example, the total length of walkways in Hong Kong is well over 2,500 kilometres. As urban areas develop to become more pedestrian friendly, the implementation of multiple urban development plans will increase the total length of paved pedestrian areas.

Since the 1980s, walkways have increasingly been paved using paving blocks; As of 2023, approximately one-third of the walkways in Hong Kong have been paved with paving blocks, amounting to a total of an estimated 66 million pieces of paving blocks being used. In accordance with the urban development and urban renewal plans, and with the need to extending pedestrian area, along with repair and renewal of existing areas, the demand for paving blocks is anticipated to greatly increase.

Attempts have been made to incorporate waste materials into various products such as paving blocks. However, prior paving blocks that use waste materials have insufficient mechanical properties, for example high load endurance, skid resistance and water absorption for long-term use in high-traffic areas while optimizing safety for the pedestrians. The present invention addresses this need.

### SUMMARY OF THE INVENTION

The paving blocks of the present invention of recycle non-biodegradable wastes and convert them into addresses the problem of mechanical properties in prior art paving blocks by providing an environmentally-friendly paving block, that incorporates waste tyre rubber, recycled plastic, and recycled glass into a strong and abrasion-resistant cement-based material for use in pedestrian areas and walkways.

Specifically, the environmentally-friendly and strengthened recycled rubber-plastic-glass paving block of the present invention comprises 16.5%-17.5% by weight of cement; 10%-15% by weight of sand; 0.1%-0.5% by weight of recycled waste tyre rubber; 0.5%-5.0% by weight of recycled plastic; 15%-20% by weight of glass cullet; 43%-47% by weight of coarse aggregate; 5%-7% by weight of water; and 0.1%-0.5% by weight of superplasticizer. The paving block has a compressive strength of at least 40 MPa.

In accordance with a first aspect of the present invention, the recycled waste tyre rubber is pulverized to an average size of 100-500 μm before being used as an ingredient for the paving blocks of the present invention.

In another embodiment, the glass cullet used for the paving blocks are of an average size of no more than 3.35 mm.

In a further embodiment, the recycled plastic is physically treated by subjecting to a rotary tumbler with ceramic media, and is further chemically treated with a binder.

In yet further embodiment, the binder is an acrylate polymer. More specifically, the acrylate polymer is selected from poly(ethyl acrylate), poly(butyl acrylate), poly(isobutyl acrylate) or poly(ethylhexyl acrylate), or a combination thereof.

In other embodiment, the superplasticizer added to the paving block of the present invention is selected from polycarboxylate ether, sulfonated melamine formaldehyde, sulfonated naphthalene formaldehyde or lignosulfonates, or a combination thereof.

In yet other embodiment, the coarse aggregate is selected from unrecycled virgin aggregate, recycled construction aggregate or a combination thereof.

In yet another embodiment, the unpolished skid resistance of the paving block is at least 70 USRV.

In other embodiment, the abrasion resistance of the paving block is no more than 23 mm.

In yet other embodiment, the paving block demonstrates a water absorption of lower than 5%.

### BRIEF DESCRIPTION OF THE DRAWINGS

Embodiments of the invention are described in more details hereinafter with reference to the drawings, in which:

FIG. 1 shows the eco-friendly sustainable paving block of the present invention;

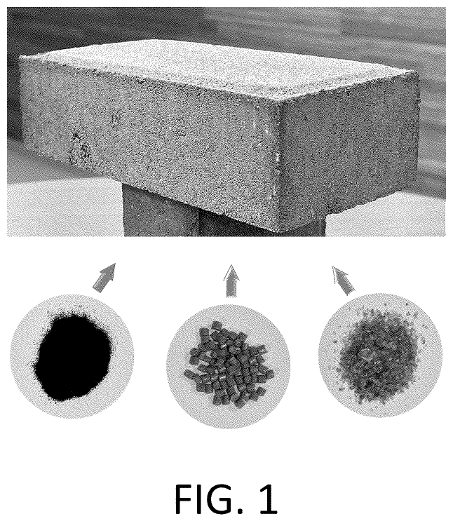

FIG. 2 shows the optical microscopy images of the surface of a paving block of the present invention before (left) and after (right) subjecting to processing by a grinder.

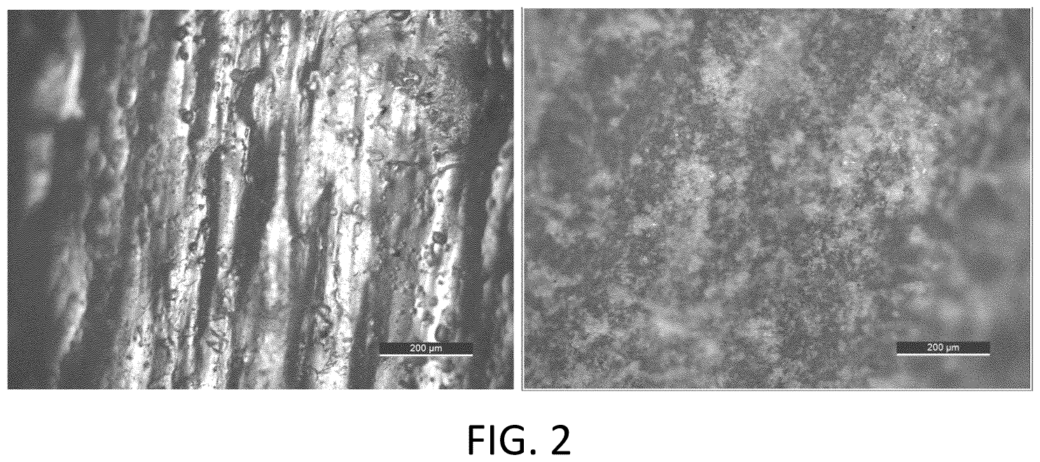

### DETAILED DESCRIPTION

A recycled rubber-plastic-glass paving block is described herein, which has a high content of recycled wastes, comprising more than 20% by weight of waste tyre rubber, recycled plastic and recycled glass, thereby having a higher waste recycling efficiency in manufacturing, providing an application for recycled materials in response to the increasing demand for waste recycling.

In particular, the waste tyre rubber, recycled plastic and recycled glass used for the manufacturing of the paving block of the present invention may be preprocessed into the forms of rubber powders, plastic pellets, and glass cullet, respectively for incorporation into the blocks.

To further enhance the mechanical properties of the paving blocks of the present invention, some of the recycled materials are subjected to physical treatment and chemical treatment respectively, which prior art paving blocks manufactured using recycled wastes often lack.

In addition, the formulation of the paving block of the present invention allows the substitution of the conventional unrecycled virgin aggregates by recycled construction aggregates, which further increases the waste recycling efficiency.

Glass cullet used as a raw material for the paving block in the present invention are made from crushing of waste glass bottles. Although glass cullet generally have high compressive strength, the smooth surface of glass cullet could lower the bonding between glass cullet and cementitious material. This situation is improved with the use of smaller sized glass cullet, which in turns increases the surface area for binding with the cementitious material.

The major constituent of glass is silicon dioxide and can react as pozzolans. Pozzolans are supplementary cementitious materials that can be added to concrete mixture to improve concrete properties. When the glass cullet are small, not only is its binding with the cementitious material improved with increased surface area, but their pozzolanic property can also be used to replace part of the cement, which will react with hydration product of cement, i.e. calcium hydroxide, to increase the compressive strength of the concrete.

However, extensive reduction the size of glass cullet by crushing and milling comes with a high cost. As such, crushing and milling the glass cullet to achieve an average size of 2.36 mm is optimum to give appropriate compressive strength within reasonable cost.

The recycled plastics used in the present invention are obtained from crushing of waste plastics. The small plastic fragments may be used directly or can be made into pellet form.

Recycled plastics are hydrophobic and usually have a smooth surface.

Therefore, they have weak bonding with cementitious materials.

In view of this, for the purpose of manufacturing the paving blocks of the present invention, the recycled plastics undergoes a physical treatment by using an industrial rotary tumbler with ceramic media. The surface would be polished and the roughness can be controlled by the tumbling time. This rough surface of the recycled plastics could increase the surface area for the bonding with cementitious materials.

Additionally, the grinded plastics is chemically treated with an acrylic binder to form a coating on the surface, which is a type of polyacrylate. The monomers of polyacrylates are acrylic acid esters. Different types of acrylic acid esters can be used, such as ethyl, butyl, isobutyl or ethylhexyl. Acrylic binders are hydrophilic because they contain chemically high polar carboxyl groups. The acrylic binder coating can increase the bonding between recycled plastics and cementitious material.

While waste tyre rubber is also a highly targeted material to be recycled and utilized in the paving block of the present invention, the incorporation of which could reduce the strength when added into the concrete. However, by controlling the amount used and using the right size of rubber powder, the reduction effect is minimized.

Coarse rubber crumb in general has a higher effect to the strength. Fine rubber powder with size of around 150 μm show minimal reduction in strength. Also, by introducing multiple sizes of different aggregates, and choosing the appropriate size range and grading of aggregates, packing density of the concrete is improved and ultimately the compressive strength is increased.

### EXAMPLES

### Example 1—Change of Plastic Content

Investigation is conducted to observe the mechanical properties, in particular the compressive strength, of the paving block by altering the plastic contents in the formulation. The results are tabulated in Table 1 below.

TABLE 1
Effects of change in plastic content on compressive strength of paving blocks

| | | | | | | | | Compressive |
|---|---|---|---|---|---|---|---|---|
| | Fine aggregate | | | | Coarse | | Super- | strength |
| Cement | Sand | Rubber | Plastic | Glass | aggregate | Water | plasticizer | (MPa) |
| 17.1% | 10.3% | 0% | 0.0% | 21.0% | 45.1% | 6.3% | 0.2% | 73.3 |
| 17.1% | 10.3% | 0.2% | 1.0% | 19.8% | 45.1% | 6.3% | 0.2% | 67 |
| 17.1% | 10.3% | 0.2% | 2.0% | 18.8% | 45.1% | 6.3% | 0.2% | 66.4 |
| 17.1% | 10.3% | 0.2% | 2.7% | 18.1% | 45.1% | 6.3% | 0.2% | 62.8 |
| 17.1% | 10.3% | 0.2% | 3.6% | 17.2% | 45.1% | 6.3% | 0.2% | 56.2 |
| 17.1% | 10.3% | 0.2% | 4.2% | 16.6% | 45.1% | 6.3% | 0.2% | 58.1 |

From Table 1, a general trend is observed that an increase in plastic content generally reduces the compressive strength.

### Example 2—Change of Glass Content

On a similar vein, the glass content used in the manufacturing of the paving blocks in the present invention is adjusted, and the compressive strengths are measured and compared in Table 2 below.

TABLE 2
Effects of change in glass content on compressive strength of paving blocks

| | | | | | | | | Compressive |
|---|---|---|---|---|---|---|---|---|
| | Fine aggregate | | | | Coarse | | Super- | strength |
| Cement | Sand | Rubber | Plastic | Glass | aggregate | Water | plasticizer | (MPa) |
| 17.1% | 13.7% | 0.2% | 2.0% | 15.4% | 45.1% | 6.3% | 0.2% | 67.2 |
| 17.1% | 12.0% | 0.2% | 2.0% | 17.1% | 45.1% | 6.3% | 0.2% | 67.1 |
| 17.1% | 10.3% | 0.2% | 2.0% | 18.8% | 45.1% | 6.3% | 0.2% | 66.4 |

The data in Table 2 shows that a change in glass content within a limited range of 3-4% would not result in a significant effect on the compressive strength of the paving blocks.

### Example 3—Change of Rubber Content

A further investigated is conducted on the effects of changes in recycled waste tyre rubber content in the paving blocks of the present invention. Results are shown as below in Table 3.

TABLE 3
Effects of change in rubber content on compressive strength of paving blocks

| | | | | | | | | Compressive |
|---|---|---|---|---|---|---|---|---|
| | Fine aggregate | | | | Coarse | | Super- | strength |
| Cement | Sand | Rubber | Plastic | Glass | aggregate | Water | plasticizer | (MPa) |
| 17.1% | 10.3% | 0.2% | 2.0% | 18.8% | 45.1% | 6.3% | 0.2% | 66.4 |
| 17.1% | 12.0% | 0.3% | 2.0% | 18.7% | 45.1% | 6.3% | 0.2% | 64.2 |
| 17.1% | 10.3% | 0.4% | 2.0% | 18.6% | 45.1% | 6.3% | 0.2% | 61.1 |

It should be noted that a slight increase in rubber content in the paving block results in a decrease in the compressive strength of the paving block. In comparison, the effect of changing the content of recycled waste tyre rubber is more significant than changing the content of recycled plastic.

### Example 4—Use of Recycled Construction Aggregate and Further Mechanical Property Test Results

From the above results, a formulation by weight of 17.1% cement, 10.3% sand, 0.2% rubber, 2.0% plastic, 18.8% glass, 45.1% coarse aggregate, 6.3% water and 0.2% superplasticizer is found to be the optimum in terms of various mechanical properties, as is shown below in Table 4.

While all the testing paving block formulations above utilize unrecycled virgin aggregate as the choice of coarse aggregate, a further investigation is conducted using the identical formulation (17.1% cement, 10.3% sand, 0.2% rubber, 2.0% plastic, 18.8% glass, 45.1% coarse aggregate, 6.3% water and 0.2% superplasticizer by weight respectively), but substituting the entirety of virgin aggregate with recycled construction aggregate. The results are tabulated in Table 4.

TABLE 4
Effects of using recycled construction aggregate
on various mechanical properties of paving blocks

| | | | Unpolished | Water |
|---|---|---|---|---|
| | Compressive | Abrasion | skid | absorp- |
| Choice of coarse | strength | resistance | resistance | tion |
| aggregate | (MPa) | (mm) | (USRV) | (%) |
| Virgin aggregate | 66.4 | 18.2 | 77.2 | 3.9 |
| Recycled construction | 41.9 | 20 | 89 | 3.6 |
| aggregate | | | | |

As observed from Table 4, replacing virgin aggregate with recycled construction aggregate results in a decrease in the compressive strength. However, the final compressive strength of 41.9 MPa is still acceptable for actual application, providing reasonable safety in terms of load-bearing capabilities. However, the abrasion resistance and unpolished skid resistance of the paving block using recycled construction aggregate is significantly increased, which are indications that paving blocks using recycled construction aggregate could actually be favorable in areas with higher humidity or rainfall, while having improved durability.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. An environmentally-friendly and strengthened recycled rubber-plastic-glass paving block comprising:
16.5%-17.5% by weight of cement;
10%-15% by weight of sand;
0.1%-0.5% by weight of recycled waste tyre rubber;
0.5%-5.0% by weight of recycled plastic;
15%-20% by weight of glass cullet;
43%-47% by weight of coarse aggregate;
5%-7% by weight of water; and
0.1%-0.5% by weight of superplasticizer;
wherein the paving block has a compressive strength of at least 40 MPa.

2. The environmentally-friendly and strengthened recycled rubber-plastic-glass paving block of claim 1, wherein the recycled waste tyre rubber is pulverized to an average size of 100-500 μm.

3. The environmentally-friendly and strengthened recycled rubber-plastic-glass paving block of claim 1, wherein the glass cullet are of an average size of no more than 3.35 mm.

4. The environmentally-friendly and strengthened recycled rubber-plastic-glass paving block of claim 1, wherein the recycled plastic is physically treated by subjecting to a rotary tumbler with ceramic media, and is further chemically treated with a binder.

5. The environmentally-friendly and strengthened recycled rubber-plastic-glass paving block of claim 4, wherein the binder is an acrylate polymer.

6. The environmentally-friendly and strengthened recycled rubber-plastic-glass paving block of claim 5, wherein the acrylate polymer is selected from poly(ethyl acrylate), poly(butyl acrylate), poly(isobutyl acrylate) or poly(ethylhexyl acrylate), or a combination thereof.

7. The environmentally-friendly and strengthened recycled rubber-plastic-glass paving block of claim 1, wherein the superplasticizer is selected from polycarboxylate ether, sulfonated melamine formaldehyde, sulfonated naphthalene formaldehyde or lignosulfonates, or a combination thereof.

8. The environmentally-friendly and strengthened recycled rubber-plastic-glass paving block of claim 1, wherein the coarse aggregate is selected from unrecycled virgin aggregate, recycled construction aggregate or a combination thereof.

9. The environmentally-friendly and strengthened recycled rubber-plastic-glass paving block of claim 1, wherein the unpolished skid resistance of the paving block is at least 70 USRV.

10. The environmentally friendly recycled rubber-plastic-glass paving block of claim 1, wherein the abrasion resistance of the paving block is no more than 23 mm.

11. The environmentally friendly recycled rubber-plastic-glass paving block of claim 1, wherein the water absorption of the paving block is lower than 5%.
